(19) United States
(12) Patent Application Publication
(10) Pub. No.: US 2008/0273675 A1
(43) Pub. Date: Nov. 6, 2008

(54) Systems And Methods For Displaying Voicemail Transcriptions

(76) Inventor: James Siminoff, Miami Beach, FL (US)

Correspondence Address: LATHROP & GAGE LC, 4845 PEARL EAST CIRCLE, SUITE 300, BOULDER, CO, 80301, US

(21) Appl. No.: 12/114,578

(22) Filed: May 2, 2008

Related U.S. Application Data
(60) Provisional application No. 60/915,775, filed on May 3, 2007.

(51) Int. Cl. H04M 11/00

(52) U.S. Cl. 379/88.14

(57) ABSTRACT

A System, method and software product manages voicemail messages and associated voicemail transcription text on a communication device. A voicemail message notification for a voicemail message is received from a voicemail transcription service and stored in a voicemail list. A transcription text of the voicemail message is received from the voicemail transcription service and stored in a text list in association with the voicemail message notification. A combined list of the voicemail message notifications and the transcribed text are displayed on the communication device.

### RELATED APPLICATIONS

This application claims priority to U.S. Provisional Application Ser. No. 60/915,775 filed May 3, 2007, and incorporated herein by reference.

### BACKGROUND

A communication subscriber may utilize a voicemail transcription service to transcribe voicemail messages into text. Such services are known in the art and typically deliver the transcribed text via email and/or one or more text messages to the subscriber.

As communication devices improve, capabilities also increase, allowing applications to become part of the communication devices. For example, mobile telephones (cell phones) are now combined with other technologies such as Personal Digital Assistants (PDAs) and provide computing platforms for applications such as e-mail, audio and video players, and web browsers. These applications integrate new functionality into the communication device to provide users with increased functionality that is easier to control and use.

### SUMMARY

However, these ‘smart’ communication devices do not provide functionality for controlling, managing and displaying voicemail transcription. Systems and methods herein serve to advance the art by controlling, managing and/or displaying voicemail transcriptions.

In an embodiment, a method manages voicemail messages and associated voicemail transcription text on a communication device. A voicemail message notification is received for a voicemail message from a voicemail transcription service, and the voicemail message notification is stored in a voicemail list. A transcription text of the voicemail message is received from the voicemail transcription service. The transcription text is stored in a text list and in association with the voicemail message notification. A combined list of the voicemail message notifications and the transcribed text is displayed on the communication device.

In another embodiment, a software product has instructions, stored on computer-readable media, wherein the instructions, when executed by a computer, perform steps for managing voicemail messages and associated voicemail transcription text on a communication device. The software product includes instructions for receiving a voicemail message notification for a voicemail message from a voicemail transcription service; instructions for storing the voicemail message notification in a voicemail list; instructions for receiving a transcription text of the voicemail message from the voicemail transcription service; instructions for storing the transcription text in a text list and in association with the voicemail message notification; and instructions for displaying a combined list of the voicemail message notifications and the transcribed text.

In another embodiment, a system displays voicemail message notifications and transcription text on a communication device. A call handler receives an unanswered call to the communication device and records a voicemail message that includes audio of the call. A transcriber transcribes the audio into text and an application, within the communication device, displays a notification of the voicemail message and the text.

### BRIEF DESCRIPTION OF THE FIGURES

FIG. 1 shows one system embodiment for displaying voicemail transcriptions on a communication device.

FIG. 2 is a flowchart illustrating one exemplary method for displaying voicemail transcriptions on a communication device, in an embodiment.

FIG. 3 shows one exemplary view of the voicemail and transcription list on the display of the device of FIG. 1, in an embodiment.

FIG. 4 shows one exemplary alternate view of the voicemail and transcription list on the display of the device of FIG. 1, in an embodiment.

FIG. 5 shows one exemplary view of transcribed text selected from the list of FIG. 4 and displayed on the display of the communication device of FIG. 1.

FIG. 6 is a flowchart illustrating one exemplary method for displaying voicemail notifications and associated transcriptions on a display of a communication device, in an embodiment.

FIG. 7 is a flowchart illustrating one exemplary method for facilitating subscriber interaction with a displayed voicemail and transcription list, in an embodiment.

### DETAILED DESCRIPTION OF THE FIGURES

Voicemail transcription services are becoming part of every day communication. When a user of a communication device is unable to take a call, a calling party typically leaves a voicemail message for the user. Where the user subscribes to a voicemail transcription service, that voicemail may be automatically transcribed into text and sent to the user, thereby allowing the user to read the transcribed voicemail message rather than listen to the voicemail message. Where the transcribed voicemail message is sent to the communication device as text message(s) and/or email message(s), the user currently changes to a different application on the communication device to view the text message(s) and/or email message(s). There is thus a need for an integrated application that manages voicemail and its associated transcription text.

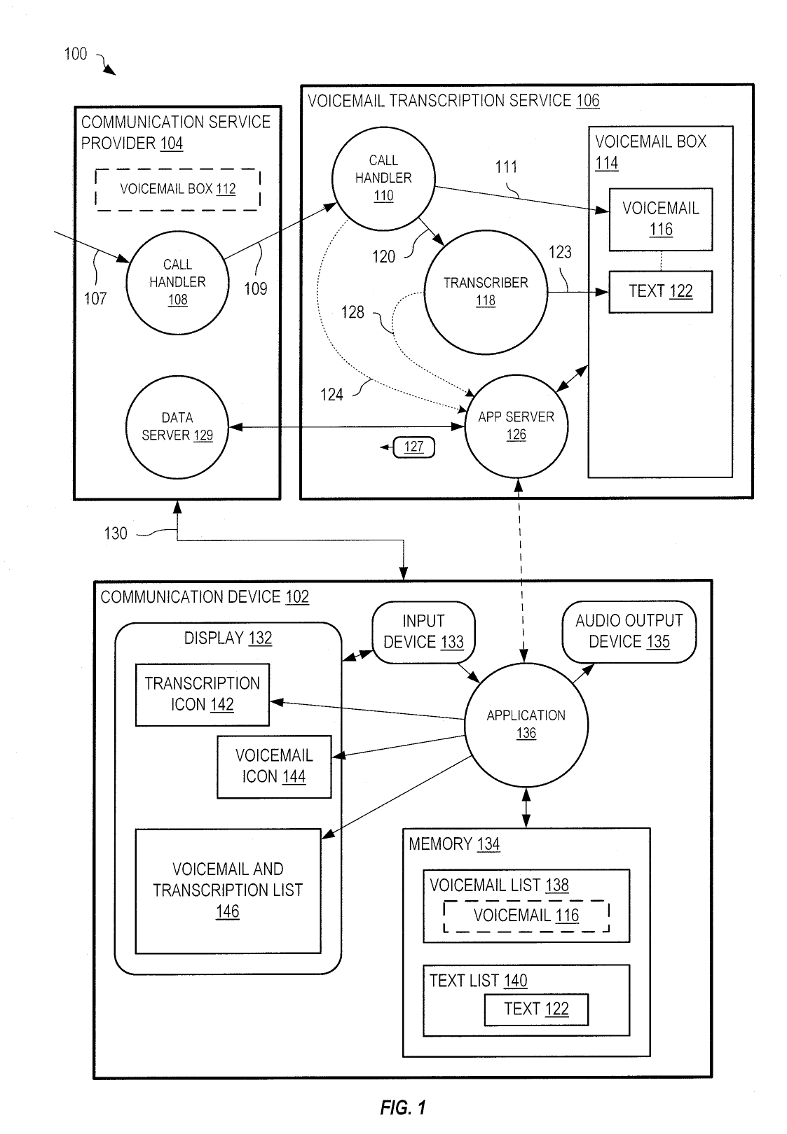

FIG. 1 shows one exemplary system 100 for displaying voicemail transcriptions. System 100 is shown with a communication device 102 of a subscriber, a communication service provider 104 and a voicemail transcription service 106. Communication device 102 is shown with a display 132, an input device 133, a memory 134, an audio output device 135 and an application 136. Communication device 102 may include other components and devices that are for example found in smart communication devices, such as a processor, input devices, audio output devices, storage devices and/or batteries, etc. These components and devices are not shown in FIG. 1 for clarity of illustration.

Communication service provider 104 includes a call handler 108 that is configured to forward unanswered calls (e.g., call 107) to a call handler 110 of voicemail transcription service 106 as call 109. Communication service provider 104 is shown with a voicemail box 112 (shown in dashed outline) that is, for example, assigned to communication device 102 but unused in view of the call forwarding to voicemail transcription service 106.

Voicemail transcription service 106 also includes a voicemail box 114 associated with communication device 102. Upon receiving forwarded call 109, call handler 110 answers the call and records 111 a voicemail message 116 to voicemail box 114. Call handler 110 may simultaneously send audio 120 of the forwarded call 109 to a transcriber 118 that transcribes audio 120 into text 122 for storage 123 within voicemail box 114, in association with voicemail 116. Text 122 may be stored elsewhere within voicemail transcription service 106 without departing from the scope hereof.

Upon termination of call 109, call handler stops recording of voicemail 116 and sends a signal 124 to an application server 126 within voicemail transcription service 106, to indicate that voicemail 116 is complete. Application server 126 may then send a voicemail notification message 127, indicating the presence of voicemail 116, to communication device 102 via a data server 129 of communication service provider 104. In one embodiment, voicemail notification message 127 includes the phone number of the caller and the start date and time of the recording.

Once transcription of audio 120 is complete, transcriber 118 sends a signal 128 to application server 126 to indicate that text 122 is complete, whereupon application server 126 sends text 122 to communication device 102 via data server 129.

In one embodiment, application server 126 sends voicemail notification message 127 and text 122 to data server 129 for forwarding to communication device 102. Data server 129 then utilizes Push technology (e.g., a Push Over-The-Air (OTA) protocol, if communication device 102 is a wireless communication device) to push voicemail notification message 127 and text 122 to application 136 within communication device 102. Data server 128 may accordingly represent a push proxy gateway (PPG).

Communication device 102 is shown communicating with communication service provider 104 via a data path 130. Data path 130 may be one or more of a wired connection, a wireless connection, a fiber optic connection and other communication means without departing from the scope hereof.

Application 136 receives voicemail notification message 127 from application server 126, via data server 129, and adds voicemail notification message 127 (or information therefrom) to a voicemail list 138 within memory 134. Application 136 may also display a voicemail icon 144 on display 132 to indicate to the subscriber that a voicemail message has been stored within voicemail box 114.

In one embodiment, where memory of communication device 102 and bandwidth of data path 130 are sufficient, application server 126 may send voicemail 116 in place of voicemail notification message 127 for storage within memory 134, as shown in dashed outline within voicemail list 138.

Application 136 also receives text 122 from application server 126 via data server 129 and stores text 122 within a text list 140 in memory 134. Application 136 may them display a transcription icon 142 on display 132 to indicate to the subscriber that a new transcribed message is available.

In an embodiment, application 136 periodically polls application server 126 for voicemail 116 and text 122.

Application 136 may generate a voicemail and transcription list 146 on display 132 based upon voicemail list 138 and text list 140. Application 136 may provide functionality to list 146 to allow the subscriber to select one or more transcriptions for viewing on display 132. For example, application 136 may allow the subscriber to select one of the listed text entries of list 146 and then switch display 132 to show the associated transcription (e.g., text 122) on display 132. In another example, where the subscriber selects a voicemail entry from list 146, application 136 may send a message to application server 126 to send audio of voicemail 116 to communication device 102, whereupon it is played for the subscriber. Where memory 134 and bandwidth of data path 130 are sufficient, voicemail 116 may already be stored within memory 134, thereby allowing application 136 to immediately play the audio of voicemail 116 without further interaction with application server 126.

Once new voicemail notification messages 127 have been viewed (e.g., within voicemail and transcription list 146) by the subscriber, application 136 may remove voicemail icon 144 from display 132, until such time as a new voicemail notification message 127 is received by application 136. Similarly, once all transcription texts entries have been viewed (e.g., within voicemail and transcription list 146) by the subscriber, application 136 may remove transcription icon 142 from display 132 until such time as a new transcription text (e.g., text 122) is received by application 136.

In one embodiment, application 136 maintains only partial information of voicemail 116 and text 122 within voicemail list 138 and text list 140, respectively, thereby reducing consumption utilization of memory 134. For example, text list 140 may contain a partial translation (i.e., part of text 122, such as a first thirty characters) of voicemail 116 rather than all of text 122; if selected for viewing by the subscriber, application 136 may then respond and interact with application server 126 to retrieve the remaining part of text 122 from voicemail box 114.

Application 136 may also allow the subscriber to delete one or more voicemails (e.g., voicemail 116) and transcriptions (e.g., text 122) from memory 134. Based upon configuration of options of application 136, this may also delete these voicemails and transcriptions from voicemail box 114. For example, by interacting with voicemail list 146, the subscriber may manage lists 138 and 140 within memory 134 and stored voicemail messages (e.g., voicemail 116) and transcribed texts (e.g., text 122) within voicemail box 114.

Where text 122 is sent to communication device 102 as one or more text messages (e.g., SMS), application 136 may reassemble these text messages for storage within text list 140 as text 122. Application 136 may also manage email and SMS text messages within memory 134 and voicemail and transcription list 146.

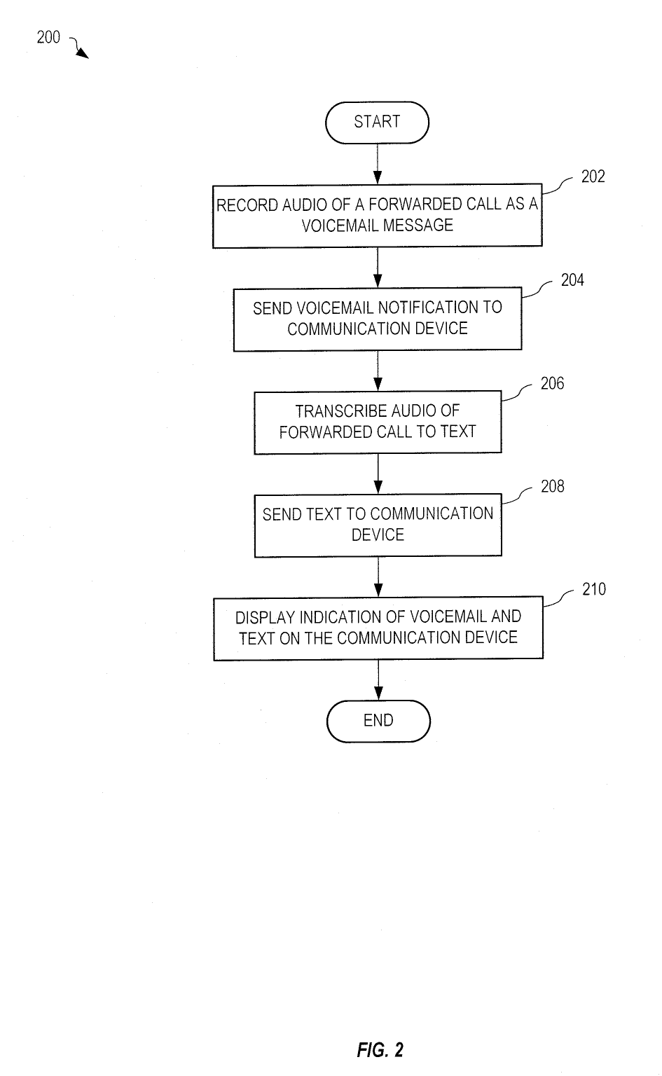

FIG. 2 is a flowchart illustrating one exemplary method 200 for displaying voicemail transcriptions on a communication device. Steps 202-208 of method 200 may be implemented within a voicemail transcription service (e.g., voicemail transcription service 106, FIG. 1). Step 210 of method 200 may be implemented within a communication device (e.g., within application 136 of communication device 102).

In step 202, method 200 records audio of a forwarded call as a voicemail message. In one example of step 202, call handler 110 records 111 audio of forwarded call 109 as voicemail 116 and stores voicemail 116 within voicemail box 114. In step 204, method 200 sends a voicemail notification to the communication device. In one example of step 204, call handler 110 sends a signal to application server 126 indicating the presence of voicemail 116; application server 126 then sends voicemail notification message 127 to communication device 102 via data server 129.

In step 206, method 200 transcribes the audio of the forwarded call into text. In one example of step 206, call handler sends audio 120 of forwarded call 109 to transcriber 118, which transcribes the audio into text 122.

Steps 202 and 206 may occur concurrently; that is, while the audio of the forwarded message is recorded as a voicemail message, the audio may be concurrently transcribed into text.

In step 208, method 200 sends the text to the communication device. In one example of step 208, transcriber 118 sends a signal to application server 126 indicating that text 122 is complete; application server 126 then sends text 122 to application 136 via data server 129, which in turn sends text 122 to communication device 102. In step 210, method 200 displays indication of voicemail and text on the communication device. In one example of step 210, application 136 creates a voicemail and transcription list 146 on display 132 of communication device 102.

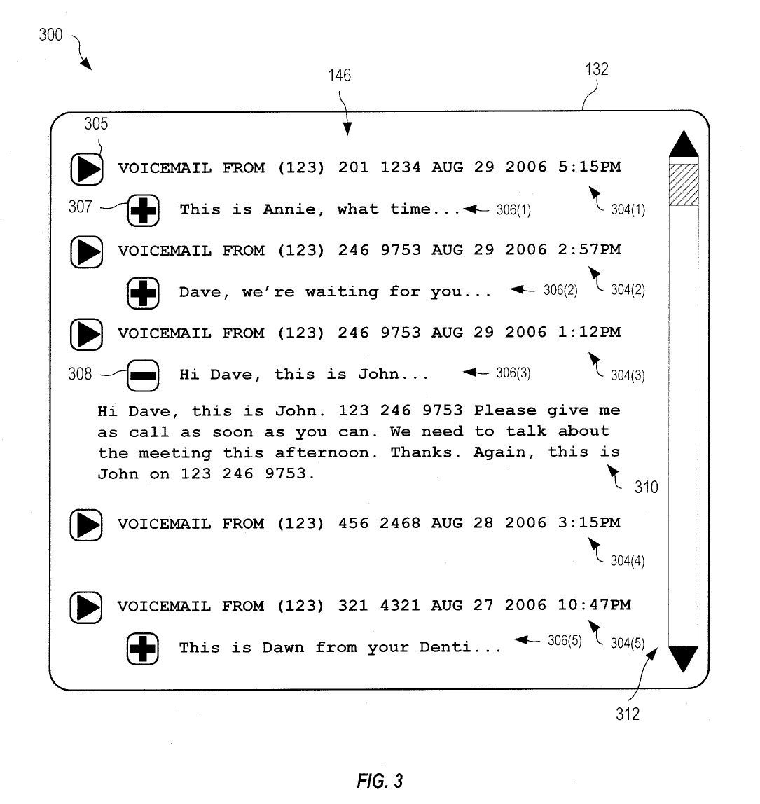

FIG. 3 shows one exemplary view 300 of voicemail and transcription list 146 on display 132 of communication device 102, FIG. 1. In the example of FIG. 3, display 132 shows five voicemail notification entries 304(1)-304(5) of list 146 and a scroll bar 312 that allows scrolling of list 146 through display 132, as controlled by the subscriber. Each voicemail notification entry 304 has an associated play button 305 that may be selected by the subscriber to play the audio of the voicemail 116 identified by the voicemail notification entry 304. In one example of operation, the subscriber utilizes input device 133 (e.g., a tracker-ball, a screen stylus, a cursor key, etc.) to select play button 305 of voicemail notification entry 304(1) and thereby play audio of voicemail message 116.

List 146 also displays a first part 306 of a text 122 of the associated voicemail message 116, if available, for each voicemail notification entry 304. Thus, view 300 lists each voicemail notification entry and a first part of the transcription of that voicemail message on display 132, thereby providing the subscriber with easily assimilated information. In particular, voicemail notification entry 304(1) is shown with a first part 306(1); voicemail notification entry 304(2) is shown with first part 306(2); voicemail notification entry 304(3) is shown with first part 306(3); and voicemail notification entry 304(5) is shown with first part 306(5). In this example, voicemail notification entry 304(4) has no associated transcription (e.g., the subscriber may have disabled automatic voicemail transcription on Aug. 28, 2006).

Each first part 306 is also shown with a display control 307/308. Display control 307 indicates that additional text is available for display, and display control 308 indicates that the additional text may be hidden from display. Upon selection, display control 307 changes to display control 308 and the full text of the associated transcription is displayed; upon selection, display control 308 changes to display control 307 and the full text is removed from display. For example, for first part 306(3), all of the associated text 122 is displayed as display text 310 and display control 308 is shown in association with first part 306(3). Thus, the subscriber may elect to display, or not, text of each associated transcription.

Further, the subscriber may select play button 305 to play audio of voicemail message 116. Once selected, application 136 interacts with application server 126 (e.g., via data server 129) to transfer the audio to communication device 102 for playing.

Application 136 may process voicemail notification 127 to identify the callers phone number within an address book of communication device 102, and to replace the phone number within voicemail notification display 304 with the associated name, thereby making view 300 easily assimilated by the subscriber.

In an embodiment, voicemail and transcription list 146 is sorted by application 136 such that the voicemail notification elements 304 are listed in reverse date and time order. That is, application 136 sorts voicemail notification entries 306 based upon date and time stored within each voicemail notification entry. The subscriber may then select the sort key as one or more of date, time and phone number of voicemail notification entry, as well as forward and reverse ordering.

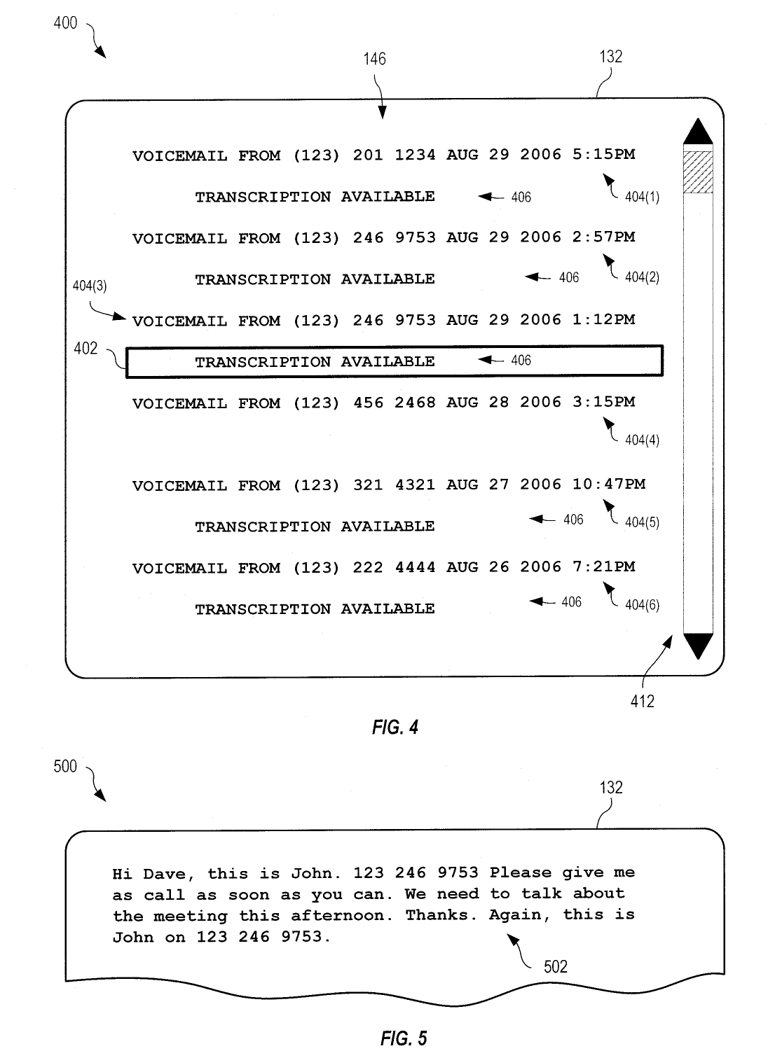

FIG. 4 shows one exemplary alternate view 400 of the voicemail and transcription list 146 on display 132 of communication device 102 of FIG. 1. In the example of FIG. 4, display 132 shows six voicemail notification entries 404(1)-404(6). Voicemail notification entries 404(1), 404(2), 404(3), 404(5) and 404(6) have an associated transcription available entry 406 indicating that voicemail transcriptions are available for those voicemail notification entries. No voicemail transcription is available for voicemail notification entry 404(4), in this example. View 400 also shows a scroll bar 412 for scrolling through entries of voicemail and transcription list 146 on display 132.

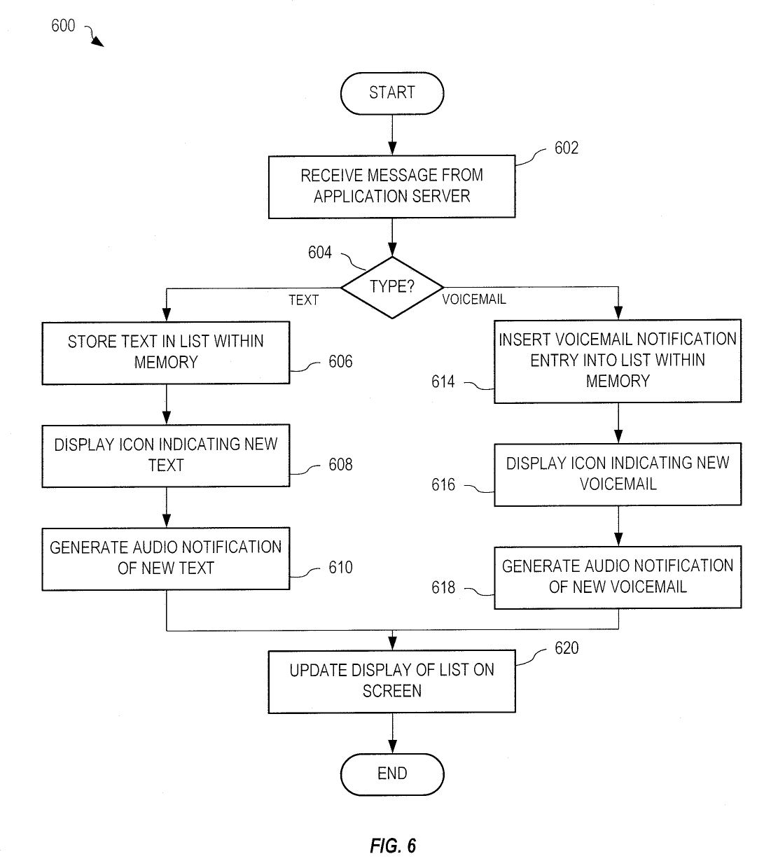

View 400 also shows a selection box 402 surrounding transcription available entry 406 of voicemail notification entry 404(3). Selection box 402 may be moved up and down (e.g., using cursor keys of input device 133) to allow the subscriber to select one of voicemail notification entries 404 and transcription available entries 406. The subscriber may select a voicemail transcription entry 404 to hear audio of the associated voicemail message (e.g., audio of voicemail 116), whereupon application 136 interacts with application server 126 via data server 129 to play the audio on communication device 102. The subscriber may also select a transcription available entry 406 whereupon application 136 retrieves the associated transcription text 122 from memory 134 and displays it upon display 132, as shown in FIG. 5. In particular, FIG. 5 shows a partial view 500 of display 132 upon which text 502 is displayed. Text 502 represents a view of text 122 that is associated with voicemail notification 404(3), in this example. In an alternate embodiment, text 502 may be displayed in a window on top of view 400.

The above embodiments and illustrative examples of voicemail and transcription may be integrated within application 136 of communication device 102.

FIG. 6 is a flowchart illustrating one exemplary method 600 for displaying voicemail notifications (e.g., voicemail notifications 304, 404 of FIGS. 3 and 4, respectively) and associated transcription text (e.g., text 122, FIG. 1) on the display (e.g., display 132) of a communication device (e.g., communication device 102). Method 600 operates within application 136 of communication device 102, for example.

In step 602, method 600 receives a message from an application server. In one example of step 602, application 136 receives a voicemail notification message 127 from application server 126 via data server 129. In another example of step 602, application 136 receives text 122 from application server 126 via data server 129.

Step 604 is a decision. If, in step 604, method 600 determines that the message received in step 602 is a transcription text, method 600 continues with step 606; otherwise method 600 continues with step 614.

In step 606, method 600 stores the received transcription text in memory of the communication device. In one example of step 606, application 136 stores text 122 within memory 134 of communication device 102. In step 608, method 600 displays an icon indicating new transcription text. In one example of step 608, application 136 displays transcription icon 142 on display 132 to indicate that a new transcription has arrived at communication device 102. In step 610, method 600 generates an audio notification of the new transcription text. Method 600 then continues with step 620. In one example of step 610, application 136 causes communication device 102 to emit subscriber-selected sound to indicate that the new text message is available for viewing.

In step 614, method 600 inserts and entry for the received voicemail notification message of step 602 into a list within memory. In one example of step 614, application 136 inserts voicemail notification message 127 into voicemail list 138 within memory 134 of communication device 102. In another example, where application server 126 sends the audio of voicemail 116, application 136 stores the audio of voicemail 116 within memory 134. In step 616, method 600 displays an icon indicating a new voicemail is available. In one example of step 616, application 136 displays voicemail icon 144 on display 132. In step 618, method 600 generates an audio notification of the new voicemail. In one example of step 618, application 136 causes communication device 102 to emit subscriber-selected sound to indicate that the new voicemail message may be listened to.

In step 620, method 600 updates the display of lists on screen. In one example of step 620, application 136 generates view 300 of voicemail and transcription list 146 on display 132. In another example of step 620, application 136 generates view 400 of voicemail and transcription list 146 on display 132.

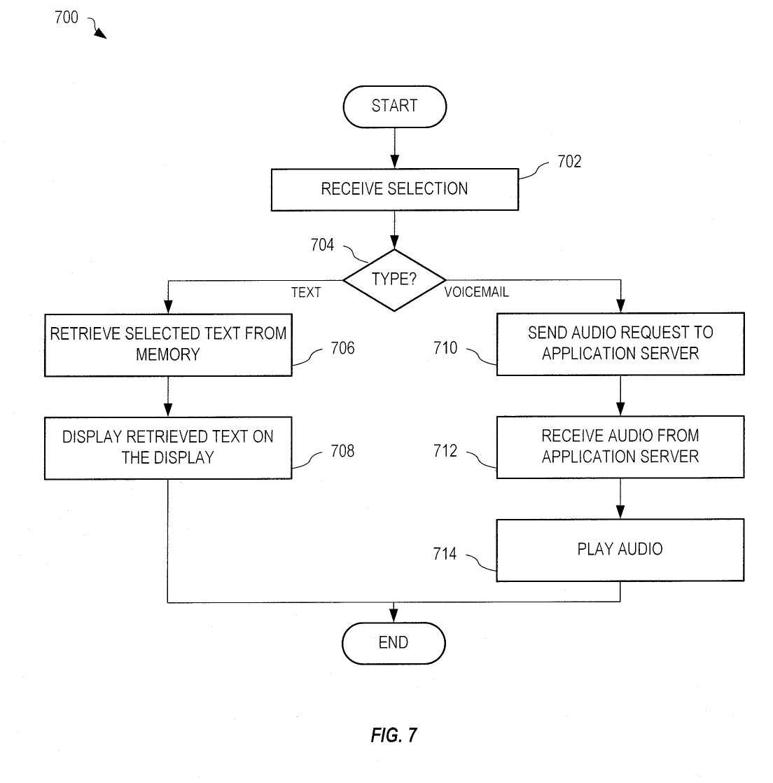

FIG. 7 is a flowchart illustrating one exemplary method 700 for allowing the subscriber to interact with the displayed voicemail and transcription list 146. Method 700 operates within application 136, FIG. 1, for example.

In step 702, method 700 receives a selection. In one example of step 702, the subscriber uses input device 133 of communication device 102 to select display control 307 of a first part 306(3) of a transcription entry of view 300, resulting in application 136 receiving the selection as an input. In another example of step 702, the subscriber uses input device 133 to move selection box 402 to highlight voicemail entry 404(3) for selection.

Step 704 is a decision. If, in step 704, method 700 determines that the received selection of step 702 is for a text transcription entry, method 700 continues with step 706; otherwise method 700 continues with step 710.

In step 706, method 700 retrieves selected text from memory. In one example of step 706, application 136 retrieves text 122 from memory 134 based upon the subscriber's selection of step 702. In step 708, method 700 displays the retrieved text on the display. In one example of step 708, text 122 is displayed within view 300 as text 310. In another example of step 708, text 122 is displayed within view 500 as text 502. Method 700 then terminates.

In step 710, method 700 sends an audio request to the application server to request the audio of the voicemail message selected in step 702. In one example of step 710, application 136 sends a request to application server 126 requesting audio of voicemail 116 to be sent to communication device 102. In step 712, method 700 receives the requested audio from the application server. In one example of step 712, application 136 receives voicemail 116 from application server 126 via data server 129. In step 714, method 700 plays the audio of the selected voicemail message. In one example of step 714, application 136 plays the audio of voicemail 116 using audio output device 135 of communication device 102.

Steps 702-714 of method 700 repeat for each selection by the subscriber.

Changes may be made in the above methods and systems without departing from the scope hereof. It should thus be noted that the matter contained in the above description or shown in the accompanying drawings should be interpreted as illustrated and not in a limiting sense. The following claims are intended to cover all generic and specific features described herein, as well as all statements of the scope of the present method and system, which, as a matter of language, might be said to fall there between.

What is claimed is:

1. A method for managing voicemail messages and associated voicemail transcription text on a communication device, comprising:
receiving a voicemail message notification for a voicemail message from a voicemail transcription service;
storing the voicemail message notification in a voicemail list;
receiving a transcription text of the voicemail message from the voicemail transcription service;
storing the transcription text in a text list and in association with the voicemail message notification; and
displaying, on the communication device, a combined list of the voicemail message notifications and the transcribed text.

2. The method of claim 1, the step of displaying further comprising sorting the combined list based upon a date and time of the voicemail message, the transcription text remaining associated with the voicemail message.

3. The method of claim 1, the step of displaying comprising displaying the voicemail message notifications and a first part of each associated transcription text.

4. The method of claim 3, further comprising displaying any un-displayed transcription text upon selection of the first part of the transcription text.

5. The method of claim 1, further comprising playing the voicemail message upon selection of the voicemail message notification within the combined list.

6. The method of claim 5, further comprising retrieving the voicemail message from the voicemail transcription service upon selection of the voicemail message notification.

7. The method of claim 1, further comprising deleting the voicemail message from a voicemail box of the voicemail transcription service when the voicemail message notification is deleted from the combined list.

8. The method of claim 1, further comprising deleting the transcription text from a voicemail box of the voicemail transcription service when the transcription text is deleted from the combined list.

9. A software product comprising instructions, stored on computer-readable media, wherein the instructions, when executed by a computer, perform steps for managing voicemail messages and associated voicemail transcription text on a communication device, comprising:
instructions for receiving a voicemail message notification for a voicemail message from a voicemail transcription service;
instructions for storing the voicemail message notification in a voicemail list;
instructions for receiving a transcription text of the voicemail message from the voicemail transcription service;
instructions for storing the transcription text in a text list and in association with the voicemail message notification; and
instructions for displaying a combined list of the voicemail message notifications and the transcribed text.

10. The software product of claim 9, further comprising instructions for sorting the combined list based upon a date and time of the voicemail message, the text remaining associated with the voicemail message.

11. The software product of claim 9, the instructions for displaying comprising instructions for displaying the voicemail message notifications and a first part of each associated transcription text.

12. The software product of claim 11, further comprising instructions for displaying any un-displayed transcription text upon selection of the first part of the transcription text.

13. The software product of claim 9, further comprising instructions for playing the voicemail message upon selection of the voicemail message notification within the combined list.

14. The software product of claim 13, further comprising instructions for retrieving the voicemail message from the voicemail transcription service upon selection of the voicemail message notification.

15. The software product of claim 9, further comprising instructions for deleting the voicemail message from a voicemail box of the voicemail transcription service when the voicemail message notification is deleted from the combined list.

16. The software product of claim 9, further comprising instructions for deleting the transcription text from a voicemail box of the voicemail transcription service when the transcription text is deleted from the combined list.

17. A system for displaying voicemail message notifications and transcription text on a communication device, comprising:
a call handler for receiving an unanswered call to the communication device, the call handler recording a voicemail message that includes audio of the call;
a transcriber for transcribing the audio into text; and
an application, within the communication device, for displaying a notification of the voicemail message and the text.

18. The system of claim 17, the application displaying a combined list of voicemail message notifications and transcribed texts.

19. The system of claim 18, the combined list including the voicemail message notifications and a first part of each associated transcription text.

20. The system of claim 19, the application displaying any un-displayed transcription text upon selection of the first part of the transcription text.

21. The system of claim 18, the application playing the voicemail message upon selection of the voicemail message notification within the combined list.

22. The system of claim 21, the application interacting with the voicemail transcription service to retrieve the voicemail message upon selection of the voicemail message notification.

23. The system of claim 18, the application interacting with the voicemail transcriptions service to delete the voicemail message from a voicemail box of the voicemail transcription service when the voicemail message notification is deleted from the combined list.

24. The system of claim 18, the application interacting with the voicemail transcriptions service to delete the transcription text from a voicemail box of the voicemail transcription service when the transcription text is deleted from the combined list.
